(19) United States
(12) Patent Application Publication
(10) Pub. No.: US 2024/0049739 A1
(43) Pub. Date: Feb. 15, 2024

(54) A CAMELLIA SINENSIS AND VITISBASED COMPOSITION AND A PROCESS OF PREPARATION THEREOF

(71) Applicant: WALTERS BAY HOLDINGS, LLC, Austin, TX (US)

(72) Inventors: Hasantha Sanjeewa WIDYARATNE, Austin, TX (US); Himansi Shamilka UBEYRATNE, Austin, TX (US)

(21) Appl. No.: 18/257,259

(22) PCT Filed: Dec. 14, 2021
(86) PCT No.: PCT/US21/63230

§ 371 Date: Jun. 13, 2023

Related U.S. Application Data
(60) Provisional application No. 63/125,016, filed on Dec. 14, 2020.

(51) Int. Cl. A23F 3/40; A23L 2/60; A23F 3/18

(52) U.S. Cl. CPC A23F 3/405; A23L 2/60; A23F 3/18

(57) ABSTRACT

Camellia Sinensis wine composition and processes of preparation thereof are described. The present disclosure provides a blend of Camellia Sinensis (Tea) (dried Camellia Sinensis, which includes, black tea, green tea, white tea, oolong tea, matcha tea and other various grades and types) and dehydrated Vitis (grape) skins of all Vitis varietals, and the addition of natural and/or artificial flavors is a foundation of disclosed beverage. The blend of mixed dried tea leaves and dehydrated Vitis skins further includes multiple flavors including various herbs and spices in specific mixing ratios to obtain a composition that may be used in a beverage or a foodstuff. Tea antioxidant and Vitis skin resveratrol when mixed will offer a unique beverage high in natural polyphenol content with natural caffeine.

### CROSS-REFERENCE TO RELATED APPLICATION

The present application claims the benefit of and priority to U.S. Provisional Application No. 63/125,016 filed Dec. 14, 2020, entitled “A SYSTEM AND A PROCESS FOR MANUFACTURING READY-TO-DRINK TEA WINE,” the contents of which being incorporated by reference in their entirety herein.

### FIELD OF THE DISCLOSURE

The present disclosure generally relates to beverage brewing methods and in particular, the present disclosure relates to a process and a composition for manufacturing alcoholic and non-alcoholic Ready-To-Drink tea wine.

### BACKGROUND

Beverages such as coffee or Camellia Sinensis (tea) are very popular and common among various types of people in different cultures and in numerous countries around the world. Over the last few decades, the coffee and tea industries have evolved from a commodity-based industry to one of specialty products. Tea is known to be the second highest consumed beverage after water in the world. However, the entire evolution of the tea industry was built on the methods and technologies developed over 100 years. Further, a number of methods for making instant tea from tea essences are known. Recently, substantial increase is observed in consumer demand worldwide for functional beverages having distinct health or nutritional benefits. Ready-To-Drink (RTD) tea bottle category has been experiencing increasing consumer demand and RTD tea category is experiencing one of the fastest growth segments worldwide. Furthermore, the RTD tea segment is popular amongst the younger generation consumers, thus creating substantial present and future monetization opportunities for beverage companies. Tea has natural antioxidant health benefits and Vitis (grape) skins contain healthy resveratrol, which in a RTD bottle application makes a perfect functional beverage. Furthermore, the addition of other ingredients like CBD from hemp plants can further enhance the health benefits of the ultimate functional beverage.

In the existing processes involving Camellia Sinensis leaves, antioxidants and caffeine are not optimized to derive the highest health benefits of a single serving. Further, the existing methodology does not address the optimization of antioxidants or caffeine by mixing and blending various ratios of high antioxidant plants such as black Camellia Sinensis, green Camellia Sinensis and white Camellia Sinensis, mixed together with coffee beans or specific spices or grape skin Resveratrol. Further, the existing processes result in loss in nutritional values and involve several chemical processes for production.

However, Ready-To-Drink tea market has very limited offerings with known nutritional properties such as antioxidants from tea combined with the nutritional values of resveratrol from grapes as seen in wines. With these benefits, an alcoholic and non-alcoholic ready to drink tea is non-existent in the market. In view of the foregoing discussion, there exists a need to have a process and a composition for manufacturing alcoholic and non-alcoholic Ready-To-Drink Camellia Sinensis wine.

### BRIEF SUMMARY

The present disclosure generally relates to a process and a composition for manufacturing alcoholic and non-alcoholic Ready-To-Drink Camellia Sinensis (tea) wine.

In an embodiment, a composition is disclosed. The composition includes 1 to 46% by weight of dried Camellia Sinensis leaves; 1 to 27% by weight of dehydrated Vitis skins; 3 to 25% by weight of at least one flavoring agent; 1 to 10% by weight of at least one sweetener; and 1 to 5% by weight of at least one preservative. In one embodiment, the Camellia Sinensis leaves are selected from a group comprising at least one of black tea, green tea, white tea, oolong tea, matcha tea, dark tea, Pu-erh tea, and combinations thereof. In an implementation, a blend of various varietals of tea may be used. In a notable implementation, a blend of black tea, white tea and green tea gives desired results. In one embodiment, the dehydrated grape (Vitis) skins are peel off from a group of Concord, Cotton Candy, Moon Drops, Flame Seedless, Dominga, Red Globe, Crimson, Black Muscat, Centennial, Thompson Seedless, Autumn Royal, Tempranillo, Glenora, Marquis, Koshu, Kyoho and combinations thereof.

In an embodiment, the Camellia Sinensis includes black tea, green tea and white tea with various herbs and fruits, wherein the black tea is used to manufacture black tea merlot, black tea cabernet sauvignon and black tea pinot noir ready to drink tea, wherein the green tea is used to manufacture green tea Riesling and green tea sauvignon blanc ready to drink tea, wherein white tea is used to manufacture white tea chardonnay ready to drink, wherein a plurality of other flavors of different tea and grape varietals are manufactured upon varying taste and amount of flavor.

In an embodiment, the present disclosure provides for a process for preparing a composition comprising blending 2-46% by weight of dried Camellia Sinensis leaves with 2-27% by weight of dehydrated Vitis skins to obtain a blend; adding 3 to 25% by weight of at least one flavoring agent, and 1 to 10% by weight of at least one sweetener to the blend; and adding 1 to 5% by weight of at least one preservative for preservation.

In an embodiment, the composition may be used at least in one of a beverage, foodstuff.

In an embodiment, a composition for manufacturing ready to drink beverages comprising black tea, green tea, white tea (Camellia Sinensis), herbs with dehydrated grape skins, plurality of wines, cannabidiol (CBD), tetrahydrocannabinol (THC), artificial sweeteners and its composition.

In an embodiment, the Camellia Sinensis-grape skin ingredient mix is offered as a fresh brewed iced Camellia Sinensis pouch for the fresh brewed iced Camellia Sinensis use in residential or commercial use.

An object of the present disclosure is to provide a process for manufacturing ready to drink beverages.

Another object of the present disclosure is to manufacture alcoholic and non-alcoholic ready to drink beverages.

Another object of the present disclosure is to produce a Camellia Sinensis-grape skin brew.

Another object of the present disclosure is to produce a Camellia Sinensis-grape skin brew with added CBD and THC.

Another object of the present disclosure is to produce Alcoholic and Non-Alcoholic beverages using various Camellia Sinensis and dehydrated Vitis skin.

Another object of the present disclosure is to promote nutrition aspect of antioxidant benefits from Camellia Sinensis and resveratrol nutritional benefits of grape skins combined into one easy to drink beverage in a bottle.

Yet another object of the present disclosure is to develop an eco-friendly, chemical free process for manufacturing ready to drink beverages.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram of a system for manufacturing Ready-To-Drink Camellia Sinensis wine in accordance with an embodiment of the present disclosure;

FIG. 2 illustrates a flow chart of a process for manufacturing Ready-To-Drink Camellia Sinensis wine in accordance with an embodiment of the present disclosure;

FIG. 3 illustrates a flow chart of a process for manufacturing Ready-To-Drink Camellia Sinensis wine with pre-blended Camellia Sinensis/grape skin bulk blend and thereby sending to bottler for adding flavor in accordance with an embodiment of the present disclosure;

FIG. 4 illustrates a flow chart of a process for manufacturing Ready-To-Drink Camellia Sinensis wine with pre-blended Camellia Sinensis/grape skin bulk blend and thereby sending to bottler for adding flavor at the bottler's facility in accordance with an embodiment of the present disclosure;

FIG. 5 illustrates a flow chart of a process for sending Ready-To-Drink Camellia Sinensis wine to the bottler pre-mixed blend for adding flavor and or CBD and THC and thereafter improvising by again adding the flavor at the bottler as well to enhance the flavoring if needed in accordance with an embodiment of the present disclosure;

FIG. 6 illustrates a process flow chart for the Camellia Sinensis wine (Alcoholic) in accordance with an embodiment of the present disclosure;

FIG. 7 illustrates a process flow chart for the Camellia Sinensis wine (Non-Alcoholic) in accordance with an embodiment of the present disclosure; and

FIG. 8 illustrates a process flow for preparing a beverage enriched with healthy antioxidant and natural caffeine in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

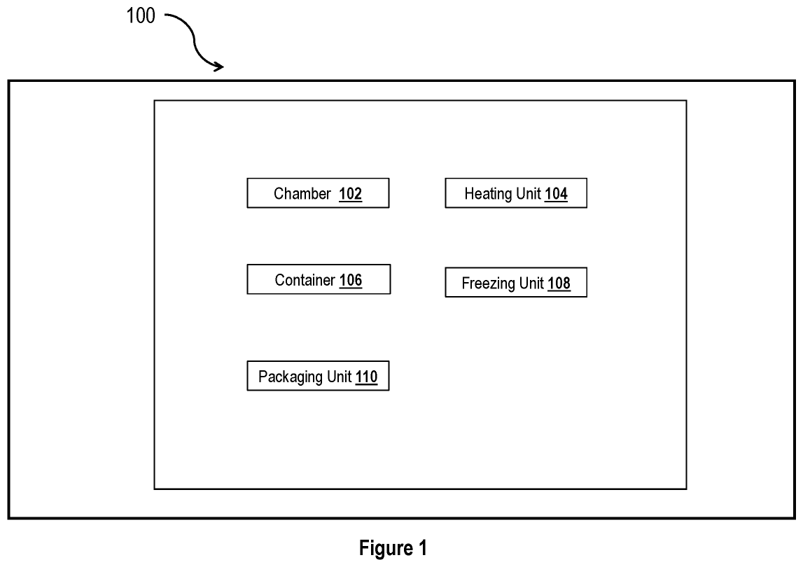

Referring to FIG. 1, a block diagram of a system for manufacturing Ready-To-Drink Camellia Sinensis and grape (vits) wine is illustrated in accordance with an embodiment of the present disclosure. The system 100 comprises a chamber 102 for mixing Camellia Sinensis with various herbs and grape skins. The various herbs include leafy green or flowering parts of a plant (either fresh or dried), while spices are usually dried and produced from other parts of the plant, including seeds, bark, roots and fruits. The grape skin is an external layer of the fruit of the wine grape. Grapes, and grape skins come in different colors including light green, red, pink or purplish red. In addition, grape skins influence color and final flavor of Camellia Sinensis. Water is added into the chamber 102 for soaking and or infusing of the Camellia Sinensis at a varying degree of temperatures. The Camellia Sinensis includes a black tea, a green tea, a white tea and the combination thereof. The tea at varying degree of temperatures is soaked into water for a predetermined time. The predetermined time ranges from 2-24 hours selected according to the taste and aroma of the Camellia Sinensis. The chamber 102 is a temperature-controlled chamber which maintains the temperature of the Camellia Sinensis at varying degree of temperatures.

In an embodiment, a heating unit 104 is installed inside the chamber 102 for brewing the Camellia Sinensis and its combinations thereof in a vented state or closed brew chambers for a user defined amount of time for preparing a ready to drink Camellia Sinensis. The Camellia Sinensis and its combinations are mixed in various ratios for various recipes and steeped to a certain length of time. The time is varied depending upon type of Camellia Sinensis-grape wine recipe. The heating unit 104 is operated manually or automatically for the certain length of time. The brewed Camellia Sinensis vented state is maintained by limiting atmospheric gases from diffusing into the brewed Camellia Sinensis.

In an embodiment, a container 106 is used for receiving and thereby storing the Camellia Sinensis and its combinations in a vented state. The container 104 consists bottle, pouch and the like. The container 104 selected herein is an air tight container that does not allow to inhale or exhale the air.

In an embodiment, a freezing unit 108 is associated with the container 104 for freezing the brewed Camellia Sinensis in the vented state in the container 104. The Camellia Sinensis-grape skin ingredient mix is also offered as a fresh brewed iced Camellia Sinensis and vits blended pouch for the fresh brewed iced Camellia Sinensis use in residential or commercial use.

In an embodiment, a packaging unit 110 for bottling the brewed Camellia Sinensis using commercially available filling methods for preparing ready to drink Camellia Sinensis is disclosed. The method consists of hot fill, cold fill, aseptic and the like.

In an embodiment, flavors are added into the container 104 for preparing alcoholic and non-alcoholic Camellia Sinensis with vits upon adding flavours into the container for preparing alcoholic and non-alcoholic Camellia Sinensis and vits with or without CBD and THC. The flavors include artificial and natural flavors such as a plurality of liquid wines, juices, artificial and sweeteners and the like. The flavors further consist of cannabidiol (CBD) and tetrahydrocannabinol (THC) extracted either from the Hemp plant or the Marijuana plant. The alcoholic beverage/Camellia Sinensis is prepared upon mixing separately brewed multiple Camellia Sinensis such as black tea, green tea, white tea, and various herbs with multiple liquid wines at the time of bottling, wherein a plurality of other flavors of different Camellia Sinensis and grape varietals are manufactured upon varying taste and amount of flavor.

In an embodiment, various processing parameters are altered to provide changes in various sensory indicators such as appearance, color, aroma and bouquet, sweetness, body, flavor, bitterness, astringency and acidity.

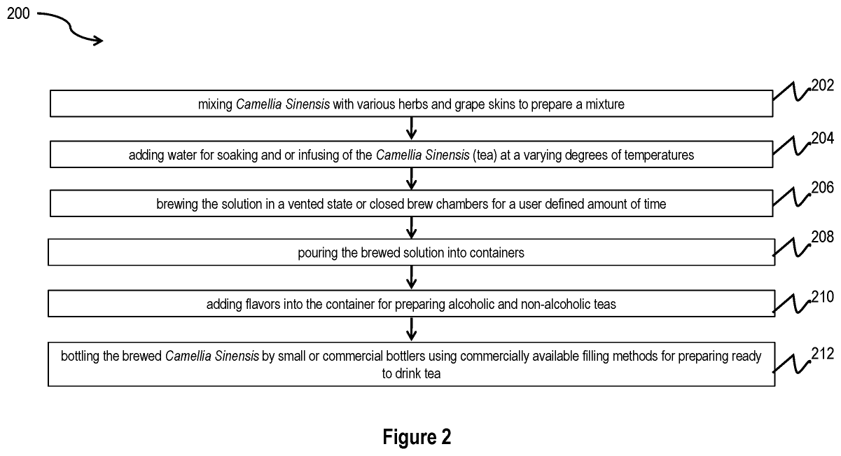

FIG. 2 illustrates a flow chart of a process for manufacturing Ready-To-Drink Camellia Sinensis wine in accordance with an embodiment of the present disclosure. At step 202, the process 200 includes mixing a Camellia Sinensis with various herbs and grape skins to prepare a mixture. The Camellia Sinensis with various herbs and grape skins are mixed manually or automatically through a machine to prepare evenly mixed mixture.

At step 204, the process 200 includes adding water for soaking and or infusing of the Camellia Sinensis at a varying degree of temperatures. The Camellia Sinensis at the varying degree of temperatures is soaked into water for a predetermined time for preparing a solution. The predetermined time is selected from the range of 2-24 hours, which varies according to the required taste of a user. The predetermined time will vary based on the Camellia Sinensis-wine infusion or the combination of the type of Camellia Sinensis and type of grape skins.

At step 206, the process 200 includes brewing the solution in a vented state or closed brew chambers for a user defined amount of time. At step 208, the process 200 includes pouring the brewed solution into container(s) 104. At step 210, the process 200 includes adding flavors into the container 104 for preparing alcoholic and non-alcoholic Camellia Sinensis upon adding flavours into the container for preparing alcoholic and non-alcoholic Camellia Sinensis with or without CBD and THC.

At step 212, the process 200 includes bottling the brewed Camellia Sinensis by small or commercial bottlers using commercially available filling methods for preparing ready to drink Camellia Sinensis.

In an embodiment, the process for manufacturing Ready-To-Drink black Camellia Sinensis comprising mixing black Camellia Sinensis with various herbs and grape skins to prepare a mixture and adding water for soaking and or infusing of the black Camellia Sinensis at varying degree of temperatures. The plurality of Camellia Sinensis at a varying degree of temperatures is soaked into water for a predetermined time for preparing a solution. The predetermined time will vary based on the Camellia Sinensis-wine infusion or the combination of the type of Camellia Sinensis and type of grape skins.

In an embodiment, the process for manufacturing Ready-To-Drink black Camellia Sinensis comprises brewing the solution in a vented state or closed brew chambers for a user defined amount of time and thereafter pouring the brewed solution into containers 104.

In an embodiment, the process for manufacturing Ready-To-Drink black Camellia Sinensis further comprising adding flavors into the container 104 for preparing alcoholic and non-alcoholic Camellia Sinensis and bottling the brewed Camellia Sinensis by small or commercial bottlers using commercially available filling methods for preparing ready to drink black tea merlot, black tea cabernet sauvignon and black tea pinot noir. A plurality of other flavors of different Camellia Sinensis and grape varietals are manufactured upon varying taste and amount of flavor.

In an embodiment, the process for manufacturing ready to drink green tea comprises mixing a green tea with various herbs and grape skins to prepare a mixture and adding water for soaking and or infusing of the green tea at a varying degree of temperatures thereafter brewing the solution in a vented state or closed brew chambers for a user defined amount of time. The predetermined time will vary based on the Camellia Sinensis-wine infusion or the combination of the type of Camellia Sinensis and type of grape skins.

In an embodiment, the process for manufacturing ready to drink green Camellia Sinensis comprising pouring the brewed solution into container(s) 104 and adding flavors into the container 104 for preparing alcoholic and non-alcoholic Camellia Sinensis thereafter bottling the brewed Camellia Sinensis by small or commercial bottlers using commercially available filling methods for preparing ready to drink green Camellia Sinensis (tea) Riesling and green tea sauvignon blanc.

In an embodiment, the process for manufacturing Ready-To-Drink white Camellia Sinensis (tea) further comprising mixing a white tea with various herbs and grape skins to prepare a mixture and adding water for soaking and or infusing of the white tea at varying degree of temperatures thereafter brewing the solution in a or closed brew chambers for a user defined amount of time. The predetermined time will vary based on the tea-wine infusion or the combination of the type of tea and type of grape skins. In an embodiment, the process for manufacturing Ready-To-Drink white tea further comprising pouring the brewed solution into container(s) 104 and adding flavors into the container 104 for preparing alcoholic and non-alcoholic tea thereafter bottling the brewed tea by small or commercial bottlers using commercially available filling methods for preparing ready to drink white tea chardonnay.

In another embodiment, a process for manufacturing ready to drink beverages is disclosed, the process further comprising mixing combinations of a plurality of Camellia Sinensis including black tea, green tea and white tea (Camellia sinensis) with various herbs and grape skins. The process further includes, adding water for soaking and or infusing of the plurality of Camellia Sinensis at a varying degree of temperatures. The plurality of Camellia Sinensis at varying degree of temperatures is soaked into water for a predetermined time. The predetermined time includes 2-24 hours. The soaking or infusing exemplifies mixing of essence of the Camellia Sinensis into the water. The predetermined time will vary based on the Camellia Sinensis-wine infusion or the combination of the type of Camellia Sinensis and type of grape skins.

The process further includes brewing combinations of the plurality of Camellia Sinensis in a vented state or closed brew chambers for a user defined amount of time. The plurality of Camellia Sinensis is mixed in various ratios for various recipes and steeped for a certain length of time. The time is varied depending on type of Camellia Sinensis-wine recipe prepared. The various ratios are selected for light, medium and hard taste of the Camellia Sinensis. The process further includes, pouring the combinations of plurality of Camellia Sinensis in a vented state into container(s) 104. The process further includes, freezing the brewed Camellia Sinensis in the vented state in the container 104. The Camellia Sinensis-grape skin ingredient mix is also offered as a fresh brewed iced Camellia Sinensis pouch for the fresh brewed iced Camellia Sinensis use in residential or commercial use.

The process further may include, adding flavors into the container 104 for preparing alcoholic and non-alcoholic Camellia Sinensis, wherein the flavors consists plurality of liquid wines, juices, artificial sweeteners and the like. The flavors further consist of cannabidiol (CBD) and tetrahydrocannabinol (THC) extracted either from the Hemp plant or the Marijuana plant.

The process further includes, bottling the brewed Camellia Sinensis by small or commercial bottlers using commercially available filling methods for preparing ready to drink Camellia Sinensis. The method consisting of hot fill, cold fill, aseptic and the like.

In an embodiment, a composition for manufacturing ready to drink beverages comprising black tea, green tea, white tea (Camellia Sinensis), herbs with dehydrated grape skins, plurality of wines, with or without cannabidiol (CBD) and tetrahydrocannabinol (THC), artificial and/or natural sweeteners and its composition.

In an embodiment, the process for manufacturing ready to drink beverages further comprising, brewing pH of the Camellia Sinensis wine prior to bottling and post bottling. The completed brew is measured for a range of colors with spectral reflectance, transmittance and/or irradiance of a Camellia Sinensis wine color and clarity, measured with a color spectrophotometer.

In an embodiment, the black, green, white tea (Camellia Sinensis) and various dried herbs to be brewed/steeped with any type of dehydrated various varietals of grape skins to create an RTD (Ready-To-Drink) Camellia Sinensis wine in a bottle. The same “bulk Camellia Sinensis-grape skin ingredient mix with flavorings can also be offered as a fresh brewed iced Camellia Sinensis pouch for the fresh brewed iced Camellia Sinensis use in residential or commercial use. The pouches are used for commercial brewing machines in food service applications and for people to use for in-home applications like a hot Tea bag. The pouches are also used as a Camellia Sinensis bag with and without ice. However, the disclosed process is related to the RTD bottled application and the fresh brewed Camellia Sinensis and grape (vits) skin bag/pouch.

In an embodiment, the concept of separately brewing Camellia Sinensis and adding dehydrated grape skin to make a Camellia Sinensis wine is disclosed in the process. The disclosed process includes making the Camellia Sinensis wine RTD bottles by mixing brewed Camellia Sinensis and separate wines together.

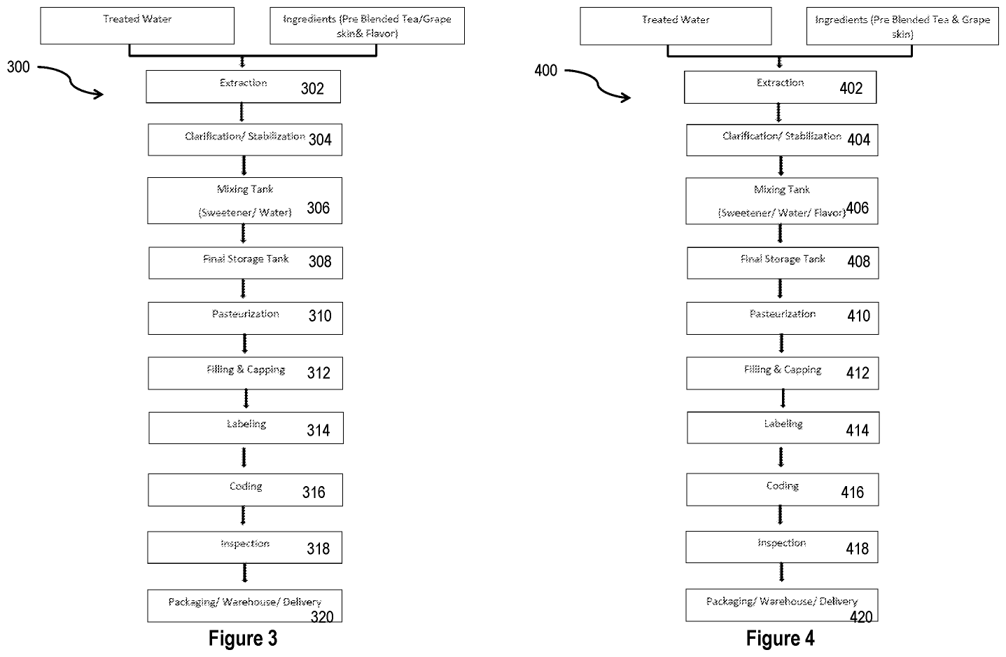

FIG. 3 illustrates a flow chart of a process for manufacturing Ready-To-Drink Camellia Sinensis wine with pre-blended Camellia Sinensis/grape skin bulk blend and thereby sending to bottler with added flavor in accordance with an embodiment of the present disclosure. At step 302, the process 300 includes extracting Camellia Sinensis wine from a solution of treated water, pre-blended Camellia Sinensis/grape skin and flavor.

At step 304, the process 300 includes clarification/stabilizing of the extracted Camellia Sinensis wine by running the extracted Camellia Sinensis wine at a given flow rate through at least two columns in parallel to achieve the highest throughput possible. At step 306, the process 300 includes mixing sweetener or water or the combination of sweetener with a variety of flavors and water inside the Camellia Sinensis wine in a mixing tank to attain a sweetened Camellia Sinensis wine, wherein the sweetener or water or flavors or their combination is mixed according to required taste.

At step 308, the process 300 includes receiving sweetened flavor Camellia Sinensis wine in a final storage tank after proper mixing of the sweetener or water or their combination. At step 310, the process 300 includes pasteurizing the sweetened Camellia Sinensis wine upon heating the sweetened Camellia Sinensis wine at high temperatures for a short time in order to kill bacteria or other microorganisms that are present inside the Camellia Sinensis wine. After pasteurization of the sweetened Camellia Sinensis wine the Camellia Sinensis wine becomes ready to drink Camellia Sinensis wine.

At step 312, the process 300 includes filling and capping the tea wine inside a container. At step 314, the process 300 includes labelling of the container of tea wine. At step 316, the process 300 includes coding the containers of the tea wine with unique codes. At step 318, the process 300 includes inspecting the containers and unique codes. At step 320, the process 300 includes packaging of the containers inside a box and thereby sending for delivery. The packaging of the containers inside the box is performed inside a warehouse.

FIG. 4 illustrates a flow chart of a process for manufacturing Ready-To-Drink Camellia Sinensis wine with pre-blended Camellia Sinensis/grape skin bulk blend and thereby sending to bottler for adding flavor at the bottler's facility in accordance with an embodiment of the present disclosure. At step 402, the process 400 includes extracting Camellia Sinensis wine from a solution of treated water, pre-blended Camellia Sinensis/grape skin and flavor.

At step 404, the process 400 includes clarification/stabilizing of the extracted Camellia Sinensis wine by running the extracted Camellia Sinensis wine at a given flow rate through at least two columns in parallel to achieve the highest throughput possible. At step 406, the process 400 includes mixing sweetener, water, flavor or their combination inside the Camellia Sinensis wine in a mixing tank to attain a sweetened Camellia Sinensis wine, wherein the sweetener, water, flavor or their combination is mixed according to required taste.

At step 408, the process 400 includes receiving sweetened flavor Camellia Sinensis wine in a final storage tank after proper mixing of the sweetener or water or the combination of sweetener and water. At step 410, the process 400 includes pasteurizing the sweetened Camellia Sinensis wine upon heating the sweetened Camellia Sinensis wine at high temperatures for a short time in order to kill bacteria or other microorganisms that are present inside the Camellia Sinensis wine. After pasteurization of the sweetened Camellia Sinensis wine, the Camellia Sinensis wine becomes ready to drink Camellia Sinensis wine.

At step 412, the process 400 includes filling and capping the Camellia Sinensis wine inside a container. At step 414, the process 400 includes labelling of the container of Camellia Sinensis wine. At step 416, the process 400 includes coding the containers of the Camellia Sinensis wine with unique codes. At step 418, the process 400 includes inspecting the containers and unique codes. At step 420, the process 400 includes packaging of the containers inside a box and thereby sending for delivery. The packaging of the containers inside the box is performed inside a warehouse.

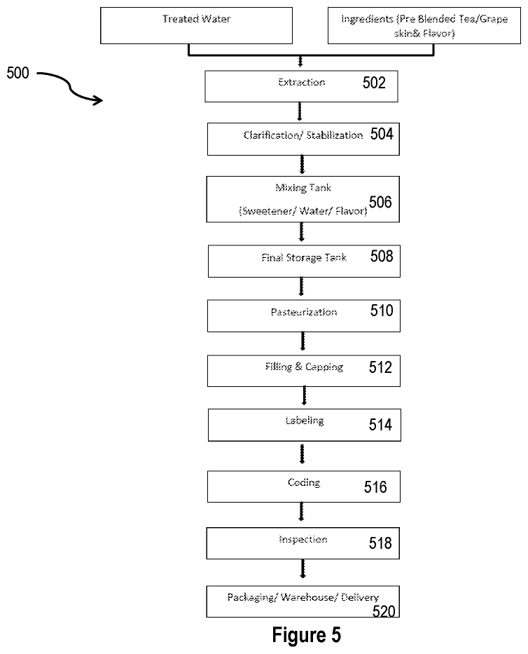

FIG. 5 illustrates a flow chart of a process for sending Ready-To-Drink Camellia Sinensis wine to the bottler pre-mixed blend for adding flavor and or CBD and THC and thereafter improvising by again adding the flavor at the bottler as well to enhance the flavoring if needed in accordance with an embodiment of the present disclosure. At step 502, the process 500 includes extracting Camellia Sinensis wine from a solution of treated water, pre-blended Camellia Sinensis/grape skin and flavor.

At step 504, the process 500 includes clarification/stabilizing of the extracted Camellia Sinensis wine by miming the extracted Camellia Sinensis wine at a given flow rate through at least two columns in parallel to achieve the highest throughput possible. At step 506, the process 500 includes mixing sweetener, water, flavor or their combination inside the Camellia Sinensis wine in a mixing tank to attain a sweetened Camellia Sinensis wine, wherein the sweetener, water, flavor and or CBD and THC and thereafter or their combination is mixed according to required taste.

At step 508, the process 500 includes receiving sweetened flavor Camellia Sinensis wine in a final storage tank after proper mixing of the sweetener or water or the combination of sweetener and water. At step 510, the process 500 includes pasteurizing the sweetened Camellia Sinensis wine upon heating the sweetened Camellia Sinensis wine at high temperatures for a short time in order to kill bacteria or other microorganisms that are present inside the Camellia Sinensis wine. After pasteurization of the sweetened Camellia Sinensis wine, the Camellia Sinensis wine becomes ready to drink Camellia Sinensis wine.

At step 512, the process 500 includes filling and capping the Camellia Sinensis wine inside a container. At step 514, the process 500 includes labelling of the container of Camellia Sinensis wine. At step 516, the process 500 includes coding the containers of the Camellia Sinensis wine with unique codes. At step 518, the process 500 includes inspecting the containers and unique codes. At step 520, the process 500 includes packaging of the containers inside a box and thereby sending for delivery. The packaging of the containers inside the box is performed inside a warehouse.

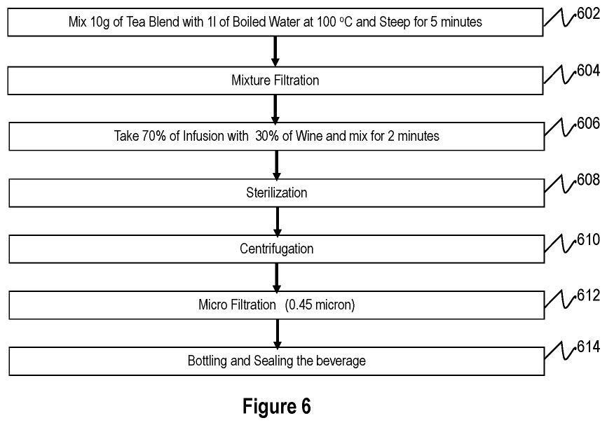

FIG. 6 illustrates a process flow chart for the Camellia Sinensis wine (Alcoholic) in accordance with an embodiment of the present disclosure. At step 602, the process 600 includes mixing 10 g of blend of composition with 1 ltr. of boiled water. The Mixture is soaked at different temperatures ranging from 50-125 degree Celsius, wherein the Camellia Sinensis is soaked in water for a predetermined time ranging from 3-10 minutes for preparing a solution at each of the different temperatures. At step 604, the process 600 includes filtering the infusion for removing large particles. At step 606, the process 600 includes taking 70% of Infusion with 30% of Wine and mixing for 2 minutes. At step 608, the process 600 includes sterilizing the mixture. At step 610, the process 600 includes centrifuging the mixture. At step 612, the process 600 includes filtering the final infusion using 0.45μ micron filtration to ensure the clarity and color consistency of product while removing the undesirable substances which were precipitated. At step 614, the process 600 includes bottling and sealing the beverage to make it ready to use beverage.

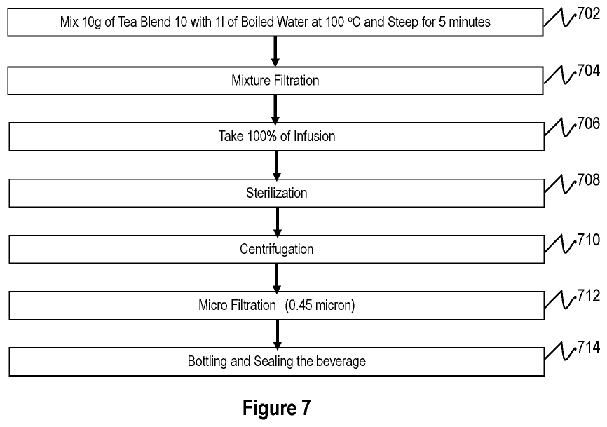

FIG. 7 illustrates a process flow chart for the Camellia Sinensis wine (Non-Alcoholic) in accordance with an embodiment of the present disclosure. At step 702, the process 700 includes mixing 10 g of Blend of the composition with 11 of Boiled Water. The Mixture is soaked at different temperatures ranging from 50-125 degree Celsius, wherein the Camellia Sinensis is soaked in water for a predetermined time ranging from 3-10 minutes for preparing a solution at each of the different temperatures. At step 704, the process 700 includes filtering the infusion for removing large particles. At step 606, the process 600 includes taking 100% of Infusion. At step 708, the process 700 includes sterilizing the mixture. At step 710, the process 700 includes centrifuging the mixture. At step 712, the process 700 includes filtering the final infusion using 0.45μ micron filtration to ensure the clarity and color consistency of product while removing the undesirable substances which were precipitated. At step 714, the process 700 includes bottling and sealing the beverage to make it ready to use beverage.

Water extraction method speeds up the oxidization process with the dissolved O₂ in water and result in a high concentrated brew. Standard steeping time was used to avoid unpleasantly bitter, over-strong taste which will occur due to the high amount of polyphenolic compounds. To maintain the clarity of brew, filtration takes place. Undissolved particles will be removed from the infusion. At room temperature, the continuous flow gets sterilized and for the process consistency Brix and pH values were analyzed. The final infusion goes through the 0.20-0.60μ micron filtration before bottling and sealing to ensure the clarity and color consistency of product while removing the undesirable substances which were precipitated. To arrest the further fermentation after botting (react with O₂), air tight sealing process can be used.

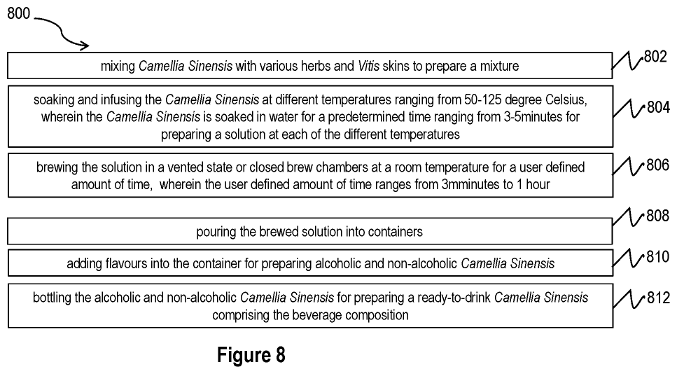

FIG. 8 illustrates a process flow for preparing a beverage enriched with healthy antioxidant and natural caffeine in accordance with an embodiment of the present disclosure. At step 802, the process 800 includes blending/mixing Camellia Sinensis leaves with various herbs and Vitis skins to prepare a blend.

At step 804, the process 800 includes adding water for soaking and infusing the blend at different temperatures ranging from 50-125 degree Celsius, wherein the blend is soaked in water for a predetermined time ranging from 3-10 minutes for preparing a solution at each of the different temperatures.

At step 806, the process 800 includes brewing the solution in a vented state or closed brew chambers at a room temperature for a user defined amount of time, wherein the user defined amount of time ranges from 3 minutes to 1 hour. At step 808, the process 800 includes pouring the brewed solution into containers. At step 810, the process 800 includes adding at least one of flavors, sweeteners, and preservatives into the container for preparing alcoholic and non-alcoholic beverage.

At step 812, the process 800 includes bottling the alcoholic and non-alcoholic Camellia Sinensis for preparing a Ready-To-Drink beverage comprising the composition.

In an embodiment, the prepared alcoholic and non-alcoholic beverage goes through a 0.20-0.60μ, notably a 0.45μ, micron filtration before bottling and sealing to remove undissolved particles to ensure the clarity and color consistency.

In an embodiment, the prepared alcoholic and non-alcoholic beverage is fermented for 1-5 hours to enhance the flavor and color which is desirable to the Camellia Sinensis wine.

In another embodiment, a composition is disclosed. The composition includes 1 to 46% by weight of dried Camellia Sinensis leaves; 1 to 27% by weight of dehydrated Vitis skins; 3 to 25% by weight of at least one flavoring agent; 1 to 10% by weight of at least one sweetener; and 1 to 5% by weight of at least one preservative.

In one embodiment, the composition further comprises spices in an amount ranging from 4 to 40% by weight, and notably 4 to 20%, wherein the spices are selected from a group comprising cinnamon, cardamom, and garcinia.

In an embodiment, the dried Camellia Sinensis leaves are selected to make at least one of black tea, green tea, white tea, oolong tea, matcha tea, dark tea, Pu-erh tea, and combinations thereof.

In an embodiment, the composition comprises a blend of 10-20% by weight of Black tea and 5-10% by weight of White tea. This composition blend contains specific 1-2% Brix, 5-6 pH, 6-9% TSS, 0.185±0.5 nm Color absorbance at 420 nm and 0.136±0.5 nm Turbidity at 660 nm.

In an embodiment, the composition comprises a blend of 5 to 15% by weight of Green tea and 5 to 15% by weight of White tea. This composition blend contains specific 0.5-1% Brix, 6-9 pH, 5-8% TSS, 0.120±0.5 nm Color absorbance at 420 nm and 0.093±0.5 nm Turbidity at 660 nm.

In an embodiment, the composition comprises a blend of 10 to 20% by weight of Black tea, 2-5% by weight of Green tea and 2-5% by weight of White tea. This composition blend contains specific 1.5-3% Brix, 4-6 pH, 8-10% TSS, 0.215±0.5 nm Color absorbance at 420 nm and 0.113±0.5 nm Turbidity at 660 nm.

In one embodiment, the dehydrated Vitis skins are peel off from a group of Concord, Cotton Candy, Moon Drops, Flame Seedless, Dominga, Red Globe, Crimson, Black Muscat, Centennial, Thompson Seedless, Autumn Royal, Tempranillo, Glenora, Marquis, and combinations thereof.

In an embodiment, the composition further comprises 5 to 65%, and notably 5- to 55%, of at least one of herbs, and fruits, wherein the herbs and fruits are selected from a group comprising of lemon, pineapple, apple, ginger, raspberry, hibiscus, rooibos, dried jackfruit, and combinations thereof. The herbs may include other fruits and vegetables depending upon the taste requirements.

In an embodiment, the flavoring agents are selected from a group comprising raspberry, blue berry, beer, wine, cider, brandy, and combinations thereof.

In an embodiment, the at least one sweetener is selected from a group comprising molasses, sugar, Stevia, Splenda, Aspartame, Sucrose, Sucralose, mannitol, sorbitol, xylitol, lactitol, isomalt, maltitol and hydrogenated starch hydrolysates (HSH).

In an embodiment, the at least one preservative is selected from a group comprising citric acid, Tartaric acid, Ascorbic acid, Vitamin C, Sorbic Acid, Potassium Sorbate, and combinations thereof.

In an embodiment, the dried Camellia Sinensis leaves contain moisture content in a range of 2 to 15%, and wherein the dehydrated Vitis skins contain moisture content in a range of 1 to 15%.

In an embodiment, the present disclosure provides for a process for preparing a composition comprising blending 2-46% by weight of dried Camellia Sinensis leaves with 2-27% by weight of dehydrated Vitis skins to obtain a blend; adding 3 to 25% by weight of at least one flavoring agent, and 1 to 10% by weight of at least one sweetener to the blend; and adding 1 to 5% by weight of at least one preservative for preservation.

In an embodiment, the composition may be used at least in one of a beverage, foodstuff.

In an embodiment, compressed CO₂ is added for carbonation of the beverage during the beverage manufacturing process.

In one embodiment, a blend of Camellia Sinensis (Tea) (dried Camellia Sinensis, which are selected to make black tea, green tea, white tea, oolong tea, matcha tea, dark tea, Pu-erh tea and other various grades and types) and dehydrated Vitis (grape) skins of all Vitis varietals, and the addition of natural and/or artificial flavors. The blend of mixed dried tea leaves and dehydrated Vitis skins further includes multiple flavors including various herbs and spices in specific mixing ratios to obtain a composition that may be used in a beverage or a foodstuff that offer exceptional nutritional benefits. Tea antioxidant and Vitis skin resveratrol when mixed, will offer a unique beverage high in natural polyphenol content with natural caffeine.

In one embodiment, mix of dried tea leaves and Vitis skins with added flavors (natural, artificial, or a combination of both) serving as the foundation for this disclosure can be mixed with various dehydrated herbs and fruits to enhance the flavor based on expert sensory evaluations. The dried ingredient mixing ratios will vary based on the target type of this beverage disclosure that may represent, but not limited to popular wine flavors such as black tea cabernet Sauvignon, black tea Merlot, black tea Pinot Noir, white tea chardonnay, white tea Rose, green tea Riesling and green tea Sauvignon Blanc.

In one embodiment, the dried mix of ingredients can be further enhanced and offered as an alcoholic and non-alcoholic beverage at the time of bottling as an RTD (Ready-To-Drink) application. Furthermore, the addition of Cannabis CBD and THC and all its variants, as an added ingredient to this beverage makes this disclosure unique and new to the consumer beverage market.

In one embodiment, the base foundation mix of dried Camellia Sinensis and dehydrated Vitis skins with added flavors can be offered in the form of dried ingredients as a tea bag for hot tea, tea bag for iced tea for in-home or retail consumer use or as a foodservice application or as a retail product, or dried bulk ingredients for RTD (Ready-To-Drink) bottle applications. Furthermore, this dried mix of ingredients can be added to various food items as well. Camellia Sinensis Composition is used from 4-36%, and notably 7-15%. Custom made intermediate zone black Camellia Sinensis were used which has total polyphenol content of 25-35% which gives dark color and flat taste.

Tea may be manufactured under regular CTC process or may be manufactured CTC process with heavy maceration using below:
Cutting process: Rotarvane parts
30 MN/m² pressure as oppose to regular CTC
800:850 rpm speed of rollers
Twist & Curl (Maceration)
30 MN/m² Pressure
100:1000 rpm throttle
   Due to the high pressure and rotarvane speed, additional heat can be generated which will badly affect the final product. Excess humidifiers are used to control over heat generation.

The chlorophyll content of green leaf varies from 01 to 0.8% on a dry weight basis. The color of the final product depends on the chlorophyll degradation pattern. Carotenoids are considered as precursors for volatile components of black Camellia Sinensis which break down during fermentation and drying. 2 hours to 3 hours fermentation process take place and this will increase the flavor and color which is desirable to the Camellia Sinensis wine along with the flat taste of Camellia Sinensis wine. With the longer fermentation time, Thearubigins will increase and give the dark color to Camellia Sinensis. Thearubigins are reddish brown in color and may make up to 10 to 20% of the dry weight of Camellia Sinensis and contribute to color, strength and mouth feel of liquor. Thearubigins are an important group of pigments formed from catechins and by oxidative degradation of Theaflavins. Furthermore, these Camellia Sinensis are usually brisker due to better aeration. Anti-oxidative property of black Camellia Sinensis is formed due to its capability to scavenge free radicals, chelate transition metal ions, and inhibit the generation of free radicals

Due to the heavy maceration and longer period of fermentation time in CTC process, 1-3% of dry weight in Theaflavin (TF) and 1-6% of dry weight in Thearubigin (TR) can be measured in Black tea by using the UV-Vis Spectrophotometer. The ratio of TF: TR will be 1:10. These specific oxidized polyphenolic compounds (TR/TF) will subjected to the specific 1.5-2% of Brix, 4.5-6.0 pH and 8-10% Total tea solids in black tea. Due to the non-oxidization in Green tea and White tea processing, TF and TR cannot be detected. High amount of catechins in Green tea and White tea is subjected to the bitter taste and it has the specific 1-1.5% Brix, 7-10 pH and 5-6% Total suspended solids TTS values.

The white Camellia Sinensis is used from approximately 4-10%. 6-20% of catechins are present which is responsible for bitterness and astringency. White Camellia Sinensis shows the more anti-mutagenic activity and higher anti-oxidant capacity which is support to cardiovascular health, cancer prevention, anti-inflammatory, anti-viral and oral care. The Vitis Skin is used from approximately 4-10%. Red Vitis skins contain an array of bioflavonoids (quercetin, catechins, flavanols, and anthocyanidins) and non-bioflavonoid polyphenols (acid derivatives). One important non-bioflavonoid in Vitis skin is resveratrol. Merlot and Cabernet Franc Vitis skins were used which has approximately 6.3-12.4 mg/dm³ resveratrol content which will give a higher antioxidant capacity as well as approximately 10-15% brix value. Notably, Anthocyanin gives the desired red color and phenolic compounds give some bitter taste. Anthocyanidins are derived from the anthocyanins and belong to the group of polyphenols. Malvidin-3-glucoside is one of the red pigments found in the skin of Vitis and act as the color stabilization. Procyanidins, a subgroup of the flavonoid polyphenols is the reason of their chemical structure, water-soluble and possess a low molecular weight (mol. wt. <7000), which makes them highly bioavailable. Physiologically, Procyanidins have hypotensive and anti-arteriosclerotic properties, and they are regarded as being very efficient free-radical scavengers. Contains Vitamin C. The raisins is used from 3-15%.

Raisins contain phenolic acids and flavanols as well as catechins and anthocyanins. Raisins are responsible for approximately 21-23% brix value and good source of potassium (749 mg/100 g). The fiber in raisins works to lower your LDL cholesterol, which reduces strain on your heart. Lemon Peel contains γ-terpinene, terpinolene, d-limonene, and citral which act as the flavor and aroma enhancer. Responsible for 2% brix value and 4-5 pH. Lemol peel have high antioxidant capacity and boost the immune system. Pineapple is an important source of sugars, organic acids (citric acid), essential minerals (Cu, Mg, Mn, K), fiber and vitamins (A, C, B-group). Pineapple is responsible for 14-14.5% brix value and 3-4 pH. Disease fighting ability and helps with weight loss. Apple Cut is used as it has the ability to inhibit free radicals and to chelate metals.

Ginger is used as the phenolic compounds in ginger, namely, gingerols, shogaols, and paradols, contribute to the characteristic flavor and pungency. They are responsible for approximately 3-6% brix value and 0.1 pH, and have anti-inflammatory and analgesic properties. Hibiscus & Rooibos are used to balance the acidic nature of final product. Hibiscus contain tannins, anthraquinones, quinines, phenols, flavonoids, alkaloids as well as the terpenoids. Neochlorogenic acid, chlorogenic acid, crypto chlorogenic acid, rutin, and isoquercitrin are the most common antioxidant compounds in Hibiscus. Spices (Cinnamon/Cardamom/Garcinia) are used from 2-15%. Cinnamic acid, cinnamaldehyde, and cinnamyl alcohol, and cinnamate have antioxidant, anti-inflammatory, and antibacterial properties which are used to treat diseases such as diabetes and cardiovascular disease. Major constituents identified were α-pinene, α-thujene, β-pinene, myrcene, α-terpinene, γ-terpinene, and penta-cymene in cardamom. The antioxidant content within cardamom detoxify the body, improving digestive track, blood pressure, heart and liver. Artificial Flavors is used from 1-25%. The concentration of Flavoring agent or combination of flavoring agents were added to enhance the aroma. High polyphenol content may generate the high bitterness in the infusion and molasses were added to bring the sweet flavor as well as the acidity of 6 pH while increasing the gravity of solution Cinnamic acid, cinnamaldehyde, and cinnamyl alcohol are important flavor and fragrance chemicals. Citric acid is added as a preservative. In an embodiment, apart from molasses, sugar, Stevia, Splenda, Aspartame, Sucrose, Sucralose, mannitol, sorbitol, xylitol, lactitol, isomalt, maltitol and hydrogenated starch hydrolysates (HSH) may also be used.

### Examples

Sensory Evaluation includes sample preparation of; Red Wine: 5.25 gs in to 400 ml water and steep for 5 minutes, Rose Wine: 5.25 gs in to 400 ml water and steep for 5 minutes, and White Wine: 4 gs in to 400 ml water and steep for 8 minutes. The sensory evaluation was done by the experienced taster panel.

| Characteristic | Red Wine | Rose Wine | White Wine |
|---|---|---|---|
| Aroma | +++ | + | ++ |
| Flavor | +++ | + | ++ |
| After Taste | ++ | +++ | ++ |
| Astringency | ++ | +++ | + |
| Sourness | ++ | +++ | + |

Differences were made due to the Camellia Sinensis type as well as the herbals, spices and flavors. Analytical Data on Camellia Sinensis Wine blend for non-Alcoholic beverage for 10 g sample:

| Component | Red Wine | White Wine | Rose Wine |
|---|---|---|---|
| Moisture % | 11.44-12.44 | 11.10-12.10 | 7.51-8.51 |
| Brix % | 3.16-5.16 | 1.86-3.86 | 1.13-3.13 |
| Tannin % | 6.142-7.142 | 1.9-2.9 | 2.76-3.76 |
| pH | 5.4-6.4 | 5.1-6.1 | 5.2-6.2 |
| Camellia Sinensis Solids % | 37-47 | 28-38 | 32-42 |
| Color Absorbance (420 nm) | 0.215 ± 0.5 | 0.113 ± 0.5 | 0.152 ± 0.5 |
| Turbidity Absorbance | 0.246 ± 0.5 | 0.093 ± 0.5 | 0.124 ± 0.5 |
| (660 nm) | | | |

The absorbance of color at 420 nm indicates the color differentiation among the 3 samples compared to the normal black Camellia Sinensis and the color variation as follows.

White wine<Rose Wine<Red Wine

White wine has a light color and red wine has high reddishness. The type of Camellia Sinensis has significant effect on color of infusion. The absorbance of Turbidity at 660 nm indicates the dissolved solids in the brew and higher polyphenol content is one of a key factor of 0.246 value of red wine

Analytical Data on final Camellia Sinensis Wine product for Alcoholic beverage:

| Component | Red Wine | White Wine | Rose Wine |
|---|---|---|---|
| Brix % | 7.162-8.162 | 6.943-7.943 | 6.948-7.943 |
| Tannin % | 6.16-7.16 | 2.3-3.3 | 2.95-3.95 |
| pH | 4.2-5.2 | 4.0-5.0 | 4.1-5.1 |
| Color Absorbance (420 nm) | 0.289 ± 0.5 | 0.165 ± 0.5 | 0.178 ± 0.5 |
| Turbidity Absorbance | 0.173 ± 0.5 | 0.091 ± 0.5 | 0.104 ± 0.5 |
| (660 nm) | | | |

Alcoholic Camellia Sinensis Wine has two-fold brix level than the non-Alcoholic Camellia Sinensis Wine due to the alcohol percentage and it has given the more clarity to the infusion. The brightness of infusion has increased.

A physiochemical analysis of the ready to drink beverages is conducted, physiochemical analysis indicates moisture about 8 to 45%, brix (total soluble solids) about 3 to 25%, pH about 2 to 8, titratable acidity about 4 to 10 g/L, specific gravity about 0.25 to 3.00, tannin about 5 to 20%, total polyphenols about 5 to 25 g/L, catechin about 10 to 45, resveratrol 0 to 40 mg/g, and gallic acid about 1 to 10 mg/g.

A microbial analysis of the ready to drink beverages is conducted, wherein the microbial analysis discloses a total plate count of <30,000 cfu and yeast & molds of <5,000 cfu.

A nutritional analysis of the ready to drink beverages is conducted, wherein the nutritional analysis discloses ash of 4.65±0.5 g/kg, protein of 8.49±0.2 g/kg, fat of 15±1 g/kg, fiber of 112±2 g/kg, carbohydrate of 7.4±0.2 g/kg, beta-carotene of 36-73 mg/100 g, and essential oil of 16%.

The developed process is focused on concept of blending tea leaves and grape skins to achieve a highly nutritious and healthy beverage that takes the tea polyphenols/antioxidants and Grape skin resveratrol. The process uses dehydrated Vitis skin instead of Vitis extract in order to maintain taste and nutritional values.

The present disclosure offers several advantages. Among other advantages, process disclosed herein provides a process for manufacturing ready to drink beverages. The process facilitates in manufacturing alcoholic and non-alcoholic ready to drink beverages. Furthermore, the process allows to promote nutrition aspect of antioxidant benefits from tea and resveratrol nutritional benefits of grape skins combined into one easy to drink beverage in a bottle. The process develops an eco-friendly and cost-effective process for manufacturing ready to drink beverages.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

Therefore, the following is claimed:

1. A composition, comprising:
1 to 46% by weight of dried Camellia Sinensis leaves;
1 to 27% by weight of dehydrated Vitis skins;
3 to 25% by weight of at least one flavoring agent;
1 to 10% by weight of at least one sweetener; and
1 to 5% by weight of at least one preservative.

2. The composition of claim 1, further comprising spices in an amount ranging from 4 to 40% by weight, wherein the spices are selected from a group comprising cinnamon, cardamom, garcinia, and combinations thereof.

3. The composition of claim 1, wherein the Camellia Sinensis leaves are selected from a group comprising black tea, green tea, white tea, oolong tea, matcha tea, dark tea, Pu-erh tea, and combinations thereof.

4. The composition of claim 3, wherein the composition comprises a blend of 10 to 20% by weight of Black tea and 5 to 10% by weight of White tea.

5. The composition of claim 3, wherein the composition comprises a blend of 5 to 15% by weight of Green tea and 5 to 15% by weight of White tea.

6. The composition of claim 3, wherein the composition comprises a blend of 10 to 20% by weight of Black tea, 2 to 5% by weight of Green tea and 2 to 5% by weight of White tea.

7. The composition of claim 1, wherein the dehydrated Vitis skins are peel off from a group comprising Concord, Cotton Candy, Moon Drops, Flame Seedless, Dominga, Red Globe, Crimson, Black Muscat, Centennial, Thompson Seedless, Autumn Royal, Tempranillo, Glenora, Marquis, Koshu, Kyoho, and combinations thereof.

8. The composition of claim 1, further comprising 5 to 65% by weight of at least one of herbs, and fruits, wherein the herbs and fruits are selected from a group comprising of lemon, pineapple, apple, ginger, raspberry, hibiscus, rooibos, dried jackfruit, and combinations thereof.

9. The composition of claim 1, wherein the at least one sweetener is selected from a group comprising molasses, sugar, Stevia, Splenda, Aspartame, Sucrose, Sucralose, mannitol, sorbitol, xylitol, lactitol, isomalt, maltitol and hydrogenated starch hydrolysates (HSH), and combinations thereof, and wherein the at least one preservative is selected from a group comprising citric acid, Tartaric acid, Ascorbic acid, Vitamin C, Sorbic Acid, Potassium Sorbate, and combinations thereof.

10. The composition of claim 1, wherein the at least one flavoring agent is selected from a group comprising raspberry, blueberry, beer, wine, cider, brandy, and combinations thereof.

11. The composition of claim 1, wherein the dried Camellia Sinensis leaves contain moisture content in a range of 2 to 15%, and wherein the dehydrated vitis skins contain moisture content in a range of 1 to 15%.

12. A process for preparing a composition of claim 1, comprising
blending 1 to 46% by weight of dried Camellia Sinensis leaves with 1 to 27% by weight of dehydrated Vitis skins to obtain a blend;
adding 3 to 25% of at least one flavoring agent, and 1 to 10% of at least one sweetener to the blend; and
adding 1 to 5% of at least one preservative for preservation.

13. A beverage comprising the composition of claim 1.

14. A foodstuff comprising the composition of claim 1.

15. A process for preparing a beverage including the composition of claim 1, wherein the process comprises:
(a) blending dried Camellia Sinensis leaves with dehydrated Vitis skins to prepare a mixture;
(b) adding water for soaking and infusing the blend at different temperatures ranging from 50-125 degree Celsius, wherein the blend is soaked in water for a predetermined time ranging from 3-10 minutes for preparing a solution at each of the different temperatures;
(c) brewing the solution in a vented state or closed brew chambers at a room temperature for a user defined amount of time, wherein the user defined amount of time ranges from 3 minutes to 1 hour;
(d) pouring the brewed solution into containers;
(e) adding at least one of flavours, sweeteners, and preservatives into the container for preparing alcoholic and non-alcoholic beverage; and
(f) bottling the beverage for preparing a Ready-To-Drink beverage comprising the composition.

16. The process of claim 15, wherein the prepared alcoholic and non-alcoholic beverage is fermented for 1-5 hours to enhance the flavor and color.

17. The process of claim 15, further comprising addition of compressed CO₂ for carbonation of the beverage.
